(19) United States
(12) Patent Application Publication
(10) Pub. No.: US 2009/0071937 A1
(43) Pub. Date: Mar. 19, 2009

(54) METHOD FOR MANUFACTURING FLUID EJECTING HEAD AND METHOD FOR MANUFACTURING FLUID EJECTING APPARATUS

(75) Inventor: Masahiro Yamashita, Matsumoto-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/209,507

(22) Filed: Sep. 12, 2008

(30) Foreign Application Priority Data
Sep. 13, 2007 (JP) 2007-237640

(51) Int. Cl. B44C 1/22

(52) U.S. Cl. 216/27

(57) ABSTRACT

A method for manufacturing a fluid ejecting head that includes a nozzle formation process in which a nozzle is formed in a nozzle substrate. The nozzle has a first concave portion and a smaller, corresponding second concave portion. The fluid ejecting head is assembled by combining the nozzle substrate, a cavity substrate, and an electrode substrate. As part of the method of manufacturing, an oxide-film etching process is performed in such a manner that a sidewall portion of a concave formed in an oxide film on the surface of a nozzle substrate has an inclined portion that has an angle of inclination that is obtained through isotropic etching and further that the depth-directional distance of the inclined portion is set at a value that is larger than that of the depth-directional distance of the oxide film that is etched in a subsequent oxide-film etching process.

### CROSS-REFERENCE TO RELATED APPLICATIONS

This application claims convention priority under 35 U.S.C. 119 to obtain the benefit of the earlier filing date, Sep. 13, 2007, of Japanese Patent Application No. 2007-237640. The contents of the above-identified Japanese Patent Application including the specification, drawings, and abstract are incorporated herein by reference in their entirety.

### BACKGROUND

1. Technical Field

The present invention relates to a method for manufacturing a fluid ejecting head, which includes a liquid ejecting head but not limited thereto. The invention further relates to a method for manufacturing a fluid ejecting apparatus. The fluid ejecting apparatus to which the invention is directed is provided with a fluid ejecting head that is manufactured by such a fluid-ejecting-head manufacturing method. In addition, a method for etching the surface of a silicon substrate is also described herein.

2. Related Art

An ink-jet recording apparatus that ejects ink onto a recording target medium such as a sheet of printing paper from an ink-jet head is known as an example of various kinds of fluid ejecting apparatuses. A fluid ejecting apparatus ejects fluid onto a target medium from a fluid ejecting head. A fluid ejecting apparatus of the related art, which includes an ink-jet recording apparatus as a non-limiting example thereof, is provided with a plurality of pressure generation chambers in the fluid ejecting head. Each of the plurality of pressure generation chambers is in communication with the corresponding one of a plurality of nozzle holes. When such a fluid ejecting apparatus of the related art ejects fluid, the capacity of the pressure generation chamber is changed. As a result of change in the capacity of the pressure generation chamber, fluid that is retained inside the pressure generation chamber is ejected out of the pressure generation chamber through the nozzle opening.

An electrostatic actuation scheme (i.e., electrostatic driving method) has been proposed in the related art as a method for changing the capacity of the pressure generation chamber so as to cause the ejection of fluid explained above. In the electrostatic actuation scheme, the capacity of a pressure generation chamber is changed as a result of the “temporary deformation” of the wall surface of a pressure generation chamber while utilizing an electrostatic force. For example, an electrostatic force is generated when a voltage is applied to an electrode. The wall surface of a pressure generation chamber is drawn due to the generated electrostatic force, which changes the capacity of the pressure generation chamber. An example of such an electrostatic actuation scheme is described in JP-A-11-28820.

As described in the above-identified JP-A-11-28820, each of the nozzles of an ink-jet head that is used in the configuration of an ink-jet recording apparatus that operates in an electrostatic actuation scheme is made up of a relatively large concave portion (a first concave portion) and a relatively small concave portion (a second concave portion). An open end, that is, nozzle hole, is formed on the bottom of the relatively small concave portion. Fluid is ejected through the open end. A nozzle that has the structure explained above is formed as follows. As a first step of nozzle formation, an oxide film is formed on the surface of a silicon substrate. The silicon substrate is the base substrate substance of a nozzle substrate. As the next step thereof, the oxide film that is formed on the surface of the nozzle substrate is subjected to wet etching by means of an etchant. Thereafter, the nozzle substrate is subjected to dry etching while using the oxide film as a mask.

The wet etching of the oxide film is performed as follows. A resist film is deposited on the surface of the oxide film. Then, the resist film is patterned so as to form an opening. Then, the wet etching of the oxide film is performed while using, as a mask, the resist film through which the opening is formed. In the course of etching after the start thereof, however, an etchant infiltrates into a gap region between the resist film and the oxide film. For this reason, the etching of the oxide film proceeds due to the etchant that has infiltrated into the gap region between the resist film and the oxide film. Then, as the etching of the oxide film progresses due to the etchant that has infiltrated into the gap region between the resist film and the oxide film, it could adversely affect isotropic etching that starts from the opening that is formed through the resist film. In such a case, it might not be possible to obtain a concave that has a desired shape. More specifically, it might adversely affect an angle of inclination of the sidewall portion of the concave, which is formed in the oxide film. That is, the inclination angle of the sidewall of the concave portion of the oxide film with respect to the surface of the nozzle substrate varies depending on the amount of the etchant that infiltrates into the gap region between the resist film and the oxide film. Generally speaking, the amount of an etchant that infiltrates into a gap region between a resist film and an oxide film varies depending on various conditions. For this reason, there occurs some variation/deviation in the shape of a concave portion that is formed in the oxide film by a wet etching method. Because of such variation/deviation in the shape of a concave portion that is formed in the oxide film by means of wet etching, there will occur some variation/deviation in the shape of a concave portion that is formed in the nozzle substrate, which causes variation/deviation in the shape of a nozzle. This makes it practically impossible or at best difficult to offer reliable ink-ejection performance without any adverse effects of such variation/deviation.

The above-identified problem is not unique to the formation of nozzles. The same problem applies for a variety of etching methods in which, as a first step thereof, an oxide film is formed on the surface of a silicon substrate, then, the wet etching of the oxide film that is formed on the surface of the silicon substrate is conducted by means of an etchant, and thereafter, the dry etching of the silicon substrate is conducted while using the oxide film as a mask so as to form a concave in the silicon substrate.

### SUMMARY

An advantage of some aspects of the invention is to form a concave portion (nozzle) that is substantially free from variation/deviation in shape in a substrate that is made of silicon (nozzle substrate).

In order to address the above-identified problem without any limitation thereto, the invention provides, as a first aspect thereof, a method for manufacturing a fluid ejecting head that includes a nozzle formation process in which a nozzle is formed in a nozzle substrate, the nozzle having a first concave portion and a second concave portion that is smaller than that of the first concave portion, the second concave portion being formed so as to correspond to the first concave portion, the fluid ejecting head being assembled by putting the nozzle substrate, a cavity substrate, and an electrode substrate together, the nozzle substrate being formed through the nozzle formation process, the nozzle formation process of the method for manufacturing a fluid ejecting head comprising: an oxide-film formation of forming an oxide film on the surface of the nozzle substrate; a resist-film deposition of depositing a resist film on the surface of the oxide film; a first resist-film patterning of forming an opening that corresponds to the second concave portion through the resist film; a first oxide-film etching of etching the oxide film with the use of an etchant while using the resist film as a mask after the first resist-film patterning mentioned above; a second resist-film patterning of widening the opening of the resist film to a larger opening that corresponds to the first concave portion after the first oxide-film etching mentioned above; a second oxide-film etching of etching the oxide film with the use of the etchant while using the resist film as a mask after the second resist-film patterning mentioned above; and a dry etching of forming the first concave portion and the second concave portion as a result of dry etching the nozzle substrate while using the oxide film as a mask after the second oxide-film etching mentioned above, wherein, in the first oxide-film etching mentioned above, etching is conducted in such a manner that the sidewall portion of a concave that is formed in the oxide film has an inclined portion that has an angle of inclination that is obtained through isotropic etching and further that the depth-directional distance of the inclined portion is set at a value that is larger than that of the depth-directional distance of the oxide film that is etched in the second oxide-film etching mentioned above.

In a method for manufacturing a fluid ejecting head according to the first aspect of the invention described above, the length of an etching time period in the first oxide-film etching is set at such a value that the sidewall portion of a concave that is formed in the oxide film has an inclined portion that has an angle of inclination that is obtained through isotropic etching and further that the depth-directional distance of the inclined portion is set at a value that is larger than that of the depth-directional distance of the oxide film that is etched in the second oxide-film etching. In the process of wet etching, the amount of an etchant that infiltrates into a gap region between the resist film and the oxide film has no influence on the formation of an isotropic-etch portion that has an angle of inclination obtained as a result of isotropic etching, which is the inclined portion in the nozzle formation process of the method for manufacturing a fluid ejecting head according to the first aspect of the invention described above. Since the inclined portion is not affected at all by the amount of an etchant that infiltrates into a gap region between the resist film and the oxide film, it always offers a steady shape that does not depend on conditions and thus is substantially free from variation or deviation. In addition, the depth-directional distance of the inclined portion is set at a value that is larger than that of the depth-directional distance of the oxide film that is etched in the second oxide-film etching. Therefore, the shape of the inclined portion, which has the angle of inclination obtained as a result of isotropic etching, is maintained without any significant loss during the execution of the second oxide-film etching. In the dry etching, it is possible to conduct the etching of the nozzle substrate while using a regional portion of the oxide film corresponding to the inclined portion, which is substantially free from variation/deviation in shape, as a mask. For this reason, it is possible to form, in the nozzle substrate, the second concave portion that is substantially free from variation/deviation in shape. The second concave portion functions as the tip (i.e., front end) of a nozzle, that is, a fluid ejection port from which a fluid is ejected. In this respect, a method for manufacturing a fluid ejecting head according to the first aspect of the invention described above makes it possible to form nozzles each of which has a front end that is substantially free from variation/deviation in shape. That is, a method for manufacturing a fluid ejecting head according to the first aspect of the invention described above makes it possible to form a concave portion (nozzle) that is substantially free from variation/deviation in shape in a substrate that is made of silicon (nozzle substrate).

In the method for manufacturing a fluid ejecting head according to the first aspect of the invention described above, it is preferable that, in the first oxide-film etching mentioned above, etching should be conducted in such a manner that the depth-directional distance of an area of the oxide film that is etched by the etchant that has infiltrated into a gap between the resist film and the oxide film during the execution of the first oxide-film etching mentioned above is set at a value that is smaller than that of the depth-directional distance of the oxide film that is etched in the second oxide-film etching mentioned above. With the preferred method for manufacturing a fluid ejecting head according to the first aspect of the invention, in the second oxide-film etching, it is possible to etch away the above-mentioned regional portion of the oxide film that is etched by an etchant that has infiltrated into a gap region between the resist film and the oxide film during the execution of the first oxide-film etching. By this means, it is possible to ensure that a concave portion that is formed in the oxide film is free from the adverse effects of the etchant that has infiltrated into the gap region between the resist film and the oxide film. Thus, the preferred method for manufacturing a fluid ejecting head according to the first aspect of the invention makes it possible to form a nozzle that has a shape substantially free from variation/deviation, including the first concave portion.

In order to address the above-identified problem without any limitation thereto, the invention provides, as a second aspect thereof, a method for manufacturing a fluid ejecting apparatus that is provided with a fluid ejecting head that ejects fluid onto a fluid ejection target medium, wherein the fluid ejecting head is manufactured by the above-mentioned method for manufacturing a fluid ejecting head according to the first aspect of the invention described above. A method for manufacturing a fluid ejecting head according to the first aspect of the invention described above makes it possible to form nozzles each of which has a front end that is substantially free from variation/deviation in shape. Thus, a method for manufacturing a fluid ejecting apparatus according to the second aspect of the invention described above makes it possible to manufacture a fluid ejecting apparatus that is provided with a fluid ejecting head having nozzles each of which has a front end that is substantially free from variation/deviation in shape. Therefore, a method for manufacturing a fluid ejecting apparatus according to the second aspect of the invention described above makes it possible to manufacture a fluid ejecting apparatus that offers excellent fluid-ejection performance.

### BRIEF DESCRIPTION OF THE DRAWINGS

The invention will be described with reference to the accompanying drawings, wherein like numbers reference like elements.

FIG. 1 is an exploded perspective view that schematically illustrates an example of the general structure of an ink-jet head that is manufactured by a method according to an exemplary embodiment of the invention; more specifically, FIG. 1 shows, in a perspective angle, a sectional view taken along the Y direction with the component substrates of the ink-jet head being separated from one another.

FIG. 2 is a sectional view that schematically illustrates an example of the general structure of an ink-jet head that is manufactured by a method according to an exemplary embodiment of the invention; more specifically,

FIG. 2 shows, in a non-perspective angle, a sectional view taken along the Y direction.

FIG. 3 is a sectional view that schematically illustrates an example of the operation of an ink-jet head that is manufactured by a method according to an exemplary embodiment of the invention; more specifically, FIG. 3 shows the temporary deformation of a vibrating plate inside a vibration plate deformation chamber.

FIG. 4 is a sectional view that schematically illustrates an example of the operation of an ink-jet head that is manufactured by a method according to an exemplary embodiment of the invention; more specifically, FIG. 4 shows that, after the temporary deformation thereof, the vibrating plate has returned to its original flat shape.

FIG. 5 is a flowchart that shows an example of a method for manufacturing an ink-jet head according to an exemplary embodiment of the invention.

FIG. 6 is a sectional view that schematically illustrates an example of the oxide-film formation step of a method for manufacturing an ink-jet head according to an exemplary embodiment of the invention.

FIG. 7 is a sectional view that schematically illustrates an example of the resist-film deposition step of a method for manufacturing an ink-jet head according to an exemplary embodiment of the invention.

FIG. 8 is a sectional view that schematically illustrates an example of the first resist-film patterning step of a method for manufacturing an ink-jet head according to an exemplary embodiment of the invention.

FIG. 9 is a sectional view that schematically illustrates an example of the first oxide-film etching step of a method for manufacturing an ink-jet head according to an exemplary embodiment of the invention.

FIG. 10 is a sectional view that schematically illustrates an example of a method for manufacturing an ink-jet head according to an exemplary embodiment of the invention; more specifically, FIG. 10 is a part of a set of sectional views that explains as to how the etching of an oxide film progresses.

FIG. 11 is a sectional view that schematically illustrates an example of a method for manufacturing an ink-jet head according to an exemplary embodiment of the invention; more specifically, FIG. 11 is a part of a set of sectional views that explains as to how the etching of the oxide film progresses.

FIG. 12 is a sectional view that schematically illustrates an example of a method for manufacturing an ink-jet head according to an exemplary embodiment of the invention; more specifically, FIG. 12 is a part of a set of sectional views that explains as to how the etching of the oxide film progresses.

FIG. 13 is a sectional view that schematically illustrates an example of the second resist-film patterning step of a method for manufacturing an ink-jet head according to an exemplary embodiment of the invention.

FIG. 14 is a sectional view that schematically illustrates an example of the second oxide-film etching step of a method for manufacturing an ink-jet head according to an exemplary embodiment of the invention.

FIG. 15 is a sectional view that schematically illustrates an example of the dry etching step of a method for manufacturing an ink-jet head according to an exemplary embodiment of the invention.

FIG. 16 is a perspective view that schematically illustrates an example of the inner configuration of an ink-jet printer that is provided with an ink-jet head manufactured by a method according to the present embodiment of the invention.

FIG. 17 is a flowchart that shows an example of a method for etching a silicon substrate according to an exemplary embodiment of the invention.

FIG. 18 is a sectional view that schematically illustrates an example of a method for etching a silicon substrate according to an exemplary embodiment of the invention.

FIG. 19 is a sectional view that schematically illustrates an example of a method for etching the silicon substrate according to an exemplary embodiment of the invention.

FIG. 20 is a sectional view that schematically illustrates an example of a method for etching the silicon substrate according to an exemplary embodiment of the invention.

FIG. 21 is a sectional view that schematically illustrates an example of a method for etching the silicon substrate according to an exemplary embodiment of the invention.

FIG. 22 is a sectional view that schematically illustrates an example of a method for etching the silicon substrate according to an exemplary embodiment of the invention.

FIG. 23 is a sectional view that schematically illustrates an example of a method for etching the silicon substrate according to an exemplary embodiment of the invention.

FIG. 24 is a sectional view that schematically illustrates an example of a method for etching the silicon substrate according to an exemplary embodiment of the invention.

### DESCRIPTION OF EXEMPLARY EMBODIMENTS

With reference to the accompanying drawings, a method for manufacturing a fluid ejecting head according to an exemplary embodiment of the invention is explained below. The method for manufacturing a fluid ejecting head according to an exemplary embodiment of the invention includes but not limited to a method for manufacturing a liquid ejecting head. In addition, an explanation is given of a method for manufacturing a fluid ejecting apparatus according to an exemplary embodiment of the invention that is provided with a fluid ejecting head that is manufactured by such a fluid-ejecting-head manufacturing method. Moreover, an etching method for forming a concavity in the surface of a silicon substrate is also described below. In the following description of this specification, an ink-jet head that ejects ink in an electrostatic actuation scheme (i.e., electrostatic driving method) is taken as an example of a variety of fluid ejecting heads according to various aspects of the invention. Ink, which appears in the following description of this specification, is a non-limiting example of various kinds of fluids, which will be non-restrictively defined later without any intention to narrow the scope of the invention. In addition, in the following description of this specification, an ink-jet recording apparatus that is provided with such an ink-jet head is taken as an example of a variety of fluid ejecting apparatuses according to various aspects of the invention. The ink-jet recording apparatus is hereafter referred to as an ink-jet printer. It should be noted that different scales are used for members illustrated in each of the accompanying drawings that are referred to in the following explanation so that each of the members illustrated therein has a size that is easily recognizable.

### Method for Manufacturing Fluid Ejecting Head/Method for Manufacturing Fluid Ejecting Apparatus

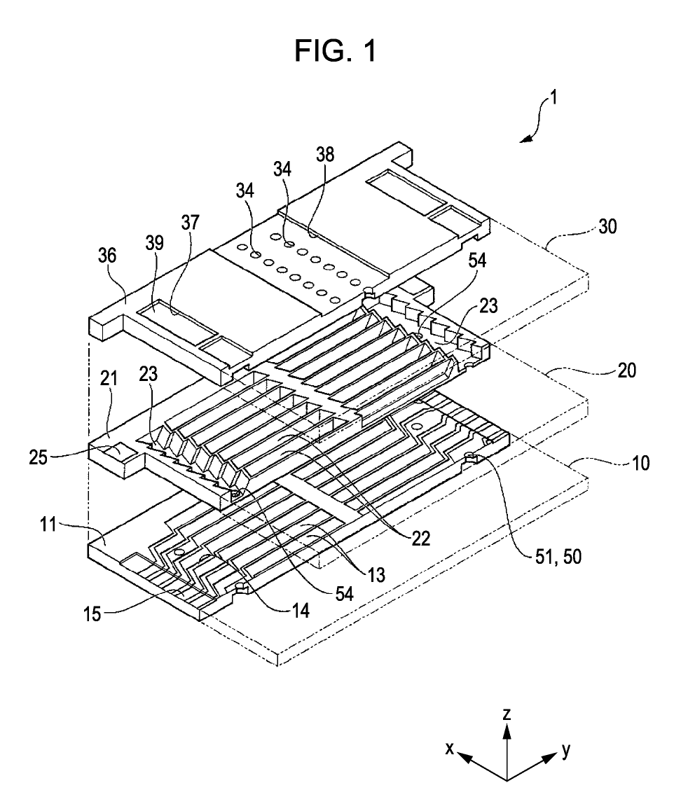

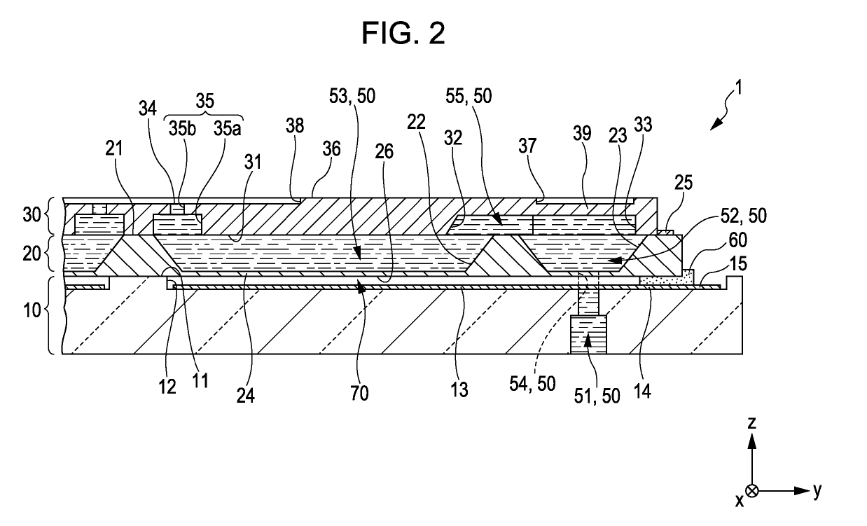

An example of the general structure of an ink-jet head 1 according to an exemplary embodiment of the invention is shown in FIGS. 1 and 2. In each of FIGS. 1 and 2, the nozzle-line direction in which a plurality of nozzles is arrayed adjacent to one another so as to form nozzle lines is denoted as the X direction. A horizontal direction that is perpendicular to the nozzle-line X direction when viewed in plan is denoted as the Y direction therein. A three-dimensional direction that is perpendicular to the X and Y directions is denoted as the Z direction therein. The Z direction corresponds to the height of the ink-jet head 1. FIG. 1 is an exploded perspective view that schematically illustrates an example of the general structure of an ink-jet head 1 that is manufactured by a method according to an exemplary embodiment of the invention; more specifically, FIG. 1 shows, in a perspective angle, a sectional view taken along the Y direction with the component substrates of the ink-jet head 1 being separated from one another. FIG. 2 is a sectional view that schematically illustrates an example of the general structure of the ink-jet head 1 that is shown in FIG. 1; more specifically, FIG. 2 shows, in a non-perspective angle, a sectional view taken along the Y direction. In order to facilitate the understanding of the structure of the ink-jet head 1, the sectional surfaces of FIGS. 1 and 2 are shifted from each other in the X direction.

As shown in FIG. 1, the ink-jet head 1 is mainly made up of an electrode substrate 10, a cavity substrate 20, and a nozzle substrate 30. Each of the electrode substrate 10, the cavity substrate 20, and the nozzle substrate 30 are formed as a component substrate of the ink-jet head 1, which has three layers as viewed in the Z direction. As shown in FIG. 2, more specifically, the cavity substrate 20 is adhered to the upper surface of the electrode substrate 10. The nozzle substrate 30 is adhered to the upper surface of the cavity substrate 20. This three-tier set of the electrode substrate 10, the cavity substrate 20, and the nozzle substrate 30 constitutes the ink-jet head 1.

Each of the cavity substrate 20 and the nozzle substrate 30 is made of silicon single crystal. The electrode substrate 10 is made of a material that has a coefficient of thermal expansion that is approximately equal to that of the material of each of the cavity substrate 20 and the nozzle substrate 30, that is, silicon single crystal. For example, the electrode substrate 10 is made of glass such as borosilicate glass or the like.

A plurality of groove portions 12 is formed in the surface of the electrode substrate 10. The groove portion 12 is shown in FIG. 2. The groove portions 12 are arrayed adjacent to one another in the X direction. In the description of this specification, the term “groove portion” has a broad meaning that encompasses, for example, a ditch portion, a channel portion, a conduit portion, a gutter portion, a recessed portion, and a concave portion without any limitation thereto. An individual electrode 13 is formed on the bottom surface of each of these groove portions 12. The individual electrode 13 generates an electrostatic force. That is, a plurality of individual electrodes 13 is arrayed adjacent to one another in the X direction on (i.e., in) the surface of the electrode substrate 10. In the illustrated exemplary configuration of the ink-jet head 1 according to the present embodiment of the invention, these individual electrodes 13 are arrayed adjacent to one another so as to form two lines. As illustrated in FIG. 1, each of the individual electrodes 13 is electrically connected to a terminal 15, which is formed in the edge region of the electrode substrate 10, via a connection line 14, which is formed on the surface of the electrode substrate 10. A voltage is applied to each of the individual electrodes 13 via the terminal 15. Each of the individual electrode 13, the connection line 14, and the terminal 15 is made of, for example, indium tin oxide (ITO) though not limited thereto.

An ink induction port 51 is formed through the electrode substrate 10 along the Z direction. The ink induction port 51 is formed at a position where the groove portion 12, the individual electrode 13, the connection line 14, and the terminal 15 are not formed. The ink induction port 51 constitutes a part of an ink flow channel 50. The ink flow channel 50 is formed as a result of the adhesion of the electrode substrate 10 and the cavity substrate 20 as well as the adhesion of the cavity substrate 20 and the nozzle substrate 30. The ink induction port 51 functions as an ink-supply inlet through which ink is supplied from the outside, such as an ink-supply source or the like, into a common ink chamber 52, which is formed through the adhesion of the cavity substrate 20 and the nozzle substrate 30. The common ink compartment 52 also constitutes a part of the ink flow channel 50. In the following description of this specification, the ink induction port 51 may be referred to as the ink-supply inlet 51.

The cavity substrate 20 is made of, for example, a silicon single crystal substrate having a crystal face orientation of (100) or (110). A plurality of groove portions 22 is formed in the upper surface 21 of the cavity substrate 20. The groove portion 22 corresponds to a pressure generation chamber (i.e., pressure generation compartment) 53. The pressure generation compartment 53 also constitutes a part of the ink flow channel 50. In addition, a groove portion 23 is formed in the upper surface 21 of the cavity substrate 20 at each side/edge thereof. The groove portion 23 corresponds to a part of the common ink chamber (i.e., common ink compartment) 52. The common ink compartment 52 also constitutes a part of the ink flow channel 50.

As illustrated in FIG. 1, the groove portions 22, each of which corresponds to the pressure generation chamber 53 as explained above, are arrayed adjacent to one another along the X direction in the surface of the electrode substrate 10. These groove portions 22 correspond to the plurality of individual electrodes 13. The pressure generation chamber 53 is formed over each of these individual electrodes 13 as a result of the adhesion of the electrode substrate 10 and the cavity substrate 20 as well as the adhesion of the cavity substrate 20 and the nozzle substrate 30. In other words, the number of the groove portions 22, each of which corresponds to the pressure generation chamber 53, is equal to the number of the individual electrodes 13 formed on the surface of the electrode substrate 10. Each of the groove portions 22 corresponding to the pressure generation chambers 53 has a bottom that is thin enough to have flexibility. The flexible bottom portion of the groove 22 functions as a vibrating plate (i.e., vibration plate) 24. The vibrating plate 24 is shown in FIG. 2. As an electrostatic force is generated when a voltage is applied to the individual electrode 13, the vibrating plate 24 is drawn downward due to the generated electrostatic force. Upon the releasing of the electrostatic force, the vibrating plate 24 reverts to its original flat shape.

As illustrated in FIG. 1, the groove portion 23, which corresponds to the common ink chamber 52 as explained above, is formed so as to extend in the X direction in each of the edge areas of the cavity substrate 20. The common ink chamber 52 is formed next to the pressure generation chambers 53 when the electrode substrate 10 and the cavity substrate 20 are adhered to each other and when the cavity substrate 20 and the nozzle substrate 30 are adhered to each other. It should be noted that, in the illustrated exemplary configuration of the ink-jet head 1 according to the present embodiment of the invention, one common ink chamber 52 is formed for each line of the pressure generation chambers 53 that are arrayed adjacent to one another in the X direction. Accordingly, the groove portion 23, which corresponds to the common ink chamber 52, is formed for each line of the groove portions 22 (which correspond to the pressure generation chambers 53) that are arrayed adjacent to one another in the X direction. That is, two groove portions 23 are formed in the illustrated exemplary configuration of the ink-jet head 1 according to the present embodiment of the invention. A through hole 54 is formed in the bottom of the groove portion 23 corresponding to the common ink chamber 52. As a result of the adhesion of the electrode substrate 10 and the cavity substrate 20, the common ink chamber 52 becomes in communication with the ink induction port (ink-supply inlet) 51, which is formed in the electrode substrate 10, via the through hole 54. Ink that is supplied from the outside enters the ink induction port 51. Then, the ink that has entered the ink-supply inlet 51 flows through this communication hole (i.e., through hole) 54 to enter the common ink chamber 52. As has already been explained above, the ink induction port 51 constitutes a part of the ink flow channel 50. The through hole 54 also constitutes a part of the ink flow channel 50.

A common electrode 25 is formed on the upper surface 21 of the cavity substrate 20. The common electrode 25 is formed at a position where the groove portions 22, which correspond to the pressure generation chambers 53, and the groove portion 23, which corresponds to the common ink chamber 52, are not formed. A voltage is applied to the cavity substrate 20 via the common electrode 25. The common electrode 25 is made of, for example, platinum (Pt), though not limited thereto.

The electrode substrate 10 and the cavity substrate 20 are adhered to each other so as to form an inner space in which the vibrating plate 24 can be temporarily deformed (e.g., drawn downward, without any limitation thereto) so as to change from its original flat shape. Each of the groove portions 12 that are formed in the surface of the electrode substrate 10 and the lower surface 26 of the cavity substrate 20 demarcates the inner space in which the vibrating plate 24 can be temporarily deformed so as to change from its original flat shape. In the following description of this specification, this space is referred to as a vibration plate deformation chamber 70. In order to avoid any foreign objects, particles, or the like from entering the vibration plate deformation chamber 70, it is hermetically sealed with the use of a sealant (i.e., sealing material) 60. Therefore, the hermetically sealed vibration plate deformation chamber 70 is isolated from the outside. The distance between the individual electrode 13 and the vibrating plate 24 determines the height of the vibration plate deformation chamber 70. The height of the vibration plate deformation chamber 70 is set at, for example, approximately 180 nm.

For example, the cavity substrate 20 is made of a silicon single crystal substrate having a crystal face orientation of (100) or (110) as has already been explained earlier. The nozzle substrate 30 is also made of a silicon single crystal substrate having a crystal face orientation of (100) or (110). The groove portions 32, 33, and 35 are formed in the lower surface 31 of the nozzle substrate 30. The groove portion 32 corresponds to an ink-supply communication conduit 55. The ink-supply communication conduit 55 constitutes a part of the ink flow channel 50. The groove portion 33 corresponds to a part of the common ink chamber 52. The groove portion 35 corresponds to a nozzle opening 34, which is a nozzle hole, nozzle orifice, or the like. Ink is ejected through the nozzle holes 34.

The cavity substrate 20 and the nozzle substrate 30 are adhered to each other in such a manner that the common ink chamber 52 is in communication with each of the plurality of pressure generation chambers 53 via the corresponding one of the plurality of ink-supply communication conduits 55, that is, via the groove portions 32. That is, the number of the groove portions 32 corresponding to the ink-supply communication conduits 55 is equal to the number of the plurality of pressure generation chambers 53.

When the cavity substrate 20 and the nozzle substrate 30 are adhered to each other, a combination of the groove portion 33 of the nozzle substrate 30 and the groove portion 23 of the cavity substrate 20 forms the common ink chamber 52. As has already been explained earlier, the groove portion 23 extends in the X direction in each of two edge areas of the cavity substrate 20. The groove portion 33 extends in the X direction in each of two edge areas of the nozzle substrate 30.

Each of the “groove” portions 35, which correspond to the nozzle openings 34, is formed as a concavity that has a columnar shape. Each of these columnar concavities 35 functions as a nozzle. Therefore, in the following description of this specification, these concavities 35 are referred to as nozzles 35. Each of the nozzles 35 is made up of a major diameter portion 35a, which has a relatively large diameter, and a minor diameter portion 35b, which has a relatively small diameter. The cavity substrate 20 and the nozzle substrate 30 are adhered to each other in such a manner that the major diameter portion 35a of the nozzle 35 is in communication with one end of the groove portion 22 of the cavity substrate 20. The minor diameter portion 35b of the nozzle 35 is formed in the bottom of the major diameter portion 35a thereof. In the illustrated exemplary configuration of the ink-jet head 1 according to the present embodiment of the invention (refer to FIG. 2), the minor diameter portion 35b of the nozzle 35 is formed immediately above the major diameter portion 35a thereof. The minor diameter portion 35b of the nozzle 35 extends from the major diameter portion 35a thereof to the upper surface 30 of the nozzle substrate 30. The major diameter portion 35a of the nozzle 35 described in the present embodiment of the invention is a non-limiting example of “a first concave portion” according to an aspect of the invention, which is relatively large. The minor diameter portion 35b of the nozzle 35 described in the present embodiment of the invention is a non-limiting example of “a second concave portion” according to an aspect of the invention, which is relatively small.

A concave portion 37 is formed in the upper surface 36 of the nozzle substrate 30. The concave portion 37 corresponds to the common ink chamber 52. Another concave portion 38 is formed in the upper surface 36 of the nozzle substrate 30. The concave portion 38 corresponds to the nozzle openings 34.

The first-mentioned concave portion 37, which corresponds to the common ink chamber 52, is formed in the upper surface 36 of the nozzle substrate 30 opposite to the groove portion 33, which is formed in the lower surface 31 of the nozzle substrate 30. A wall portion is formed between the first-mentioned concave portion 37 and the groove portion 33 of the nozzle substrate 30. The wall portion is thin enough to have flexibility. The flexible wall portion of the nozzle substrate 30 functions as a diaphragm 39. The diaphragm 39 vibrates when ink retained in the common ink chamber 52 fluctuates, for example, when ink retained in the common ink chamber 52 rises and falls. That is, the diaphragm 39 oscillates (i.e., vibrates) in accordance with the fluctuation (i.e., wave motion) of ink. Because of the oscillatory movement of the diaphragm, the wave motion of ink retained in the common ink chamber 52 is attenuated. In the illustrated exemplary configuration of the ink-jet head 1 according to the present embodiment of the invention, the diaphragm 39 operates in an oscillating (i.e., vibrating) manner in the first-mentioned concave portion 37 at a position closer to the upper surface 36 of the nozzle substrate 30.

The nozzle openings 34 are exposed at the bottom of the second-mentioned concave portion 38. Each of the nozzle holes 34 is an open end of the minor diameter portion 35b of the corresponding one of the nozzles 35. The second-mentioned concave portion 38 is formed at the entire nozzle-hole formation area at which all of the nozzle holes 34 are formed.

As has already been explained earlier, the electrode substrate 10 and the cavity substrate 20 are adhered to each other; and in addition, the cavity substrate 20 and the nozzle substrate 30 are adhered to each other. The ink flow channel 50 is formed as a result of the adhesion of the electrode substrate 10 and the cavity substrate 20 as well as the adhesion of the cavity substrate 20 and the nozzle substrate 30. The ink flow channel 50 provides an ink-supply passage from the ink induction port (i.e., ink-supply inlet) 51, which is formed in the electrode substrate 10, to the nozzle opening 34, which is formed in the nozzle substrate 30. More specifically, a combination of the groove portion 23, which is formed in each of the edge areas of the upper surface 21 of the cavity substrate 20, and the groove portion 33, which is formed in the lower surface 31 of the nozzle substrate 30, forms the common ink chamber 52. That is, the common ink chamber 52 is made up of the groove portion 23 and the groove portion 33. Each of the groove portions 22, which are formed in the upper surface 21 of the cavity substrate 20, and the lower surface 31 of the nozzle substrate 30, make up the corresponding one of the plurality of pressure generation chambers 53. On the other hand, each of the groove portions 32, which are formed in the lower surface 31 of the nozzle substrate 30, and the upper surface 21 of the cavity substrate 20, make up the corresponding one of the plurality of ink-supply communication conduits 55. That is, in the illustrated exemplary configuration of the ink-jet head 1 according to the present embodiment of the invention, the nozzle openings 34 and a portion of the ink flow channel 50 that is in communication with the nozzle opening 34 is formed in the nozzle substrate 30. In addition, in the illustrated exemplary configuration of the ink-jet head 1 according to the present embodiment of the invention, the remaining portion of the ink flow channel 50 is formed in the electrode substrate 10 and the cavity substrate 20. The electrode substrate 10 and the cavity substrate 20 are bonded to each other (e.g., through anode coupling, without any limitation thereto). The cavity substrate 20 and the nozzle substrate 30 are bonded to each other with the use of an adhesive.

The common ink chamber 52 functions as a reservoir, which retains ink that is supplied from the outside through the ink induction port 51 and the through hole 54. As has already been explained above, one common ink chamber 52 is formed for each line of the pressure generation chambers 53 that are arrayed adjacent to one another in the X direction. The ink-retaining capacity of each of the pressure generation chambers 53 fluctuates as the vibrating plate 24 is drawn downward (deformed). Each of the pressure generation chambers 53 is formed for the corresponding one of the plurality of nozzle openings 34. One end of each of the pressure generation chambers 53 is in communication with the corresponding one of the plurality of nozzles 35. The other end of each of the pressure generation chambers 53 is in communication with the corresponding one of the plurality of ink-supply communication conduits 55.

Each of the ink-supply communication conduits 55 functions as an inlet passage or a port passage for supplying ink from the common ink chamber 52 to the corresponding one of the plurality of pressure generation chambers 53. One end of each of the ink-supply communication conduits 55 is in communication with the corresponding one of the plurality of pressure generation chambers 53. The other end of each of the ink-supply communication conduits 55 is in communication with the common ink chamber 52.

The ink-jet head 1 according to the present embodiment of the invention, which has the ink flow channel structure explained above, ejects ink as follows. Ink that is supplied from the outside enters the ink induction port 51. Then, the ink that has flowed into the ink-supply inlet 51 passes through the through hole 54 to enter the common ink chamber 52. The ink that is temporarily retained in the common ink chamber 52, which functions as a reservoir, flows through each of the ink-supply communication conduits 55 and then flows into the corresponding one of the plurality of pressure generation chambers 53, which is in communication with the corresponding one of the plurality of nozzles 35.

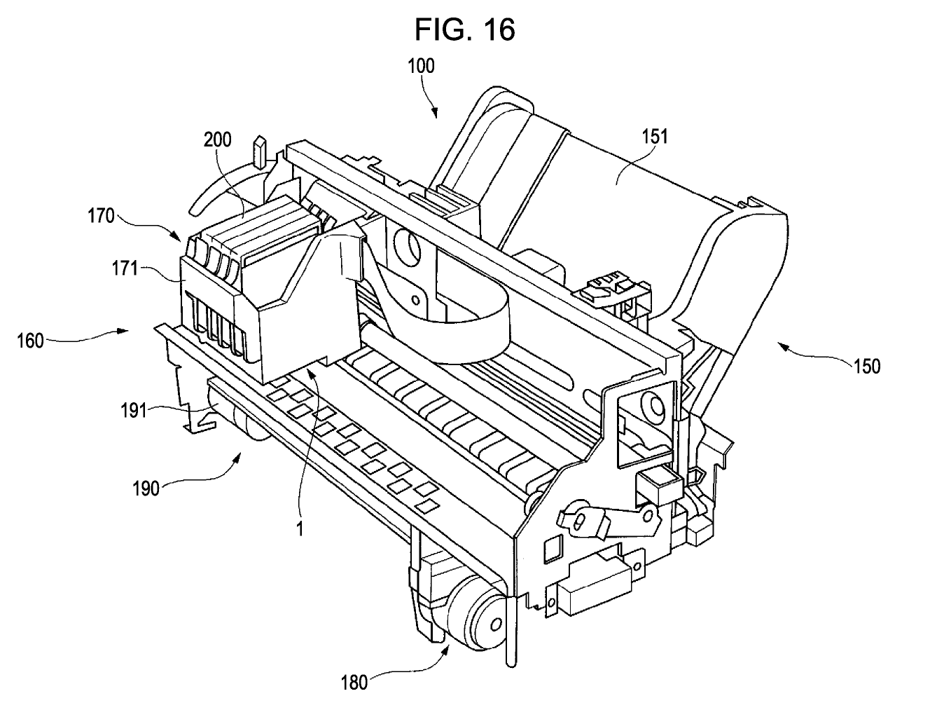

After the filling of all ink flow channel 50 with ink through the execution of the ink-supply process explained above, an external controlling unit 140 (refer to FIG. 16) applies a driving voltage to the terminals 15 of the electrode substrate 10 and the common electrode 25, the latter of which is formed on the upper surface 21 of the cavity substrate 20. Upon the application of a driving voltage to the terminals 15 of the electrode substrate 10 and the common electrode 25 of the cavity substrate 20, an electric potential difference occurs between the individual electrodes 13 of the electrode substrate 10 and the vibrating plate 24 of the cavity substrate 20. An electrostatic force is generated due to the electric potential difference that has occurred therebetween.

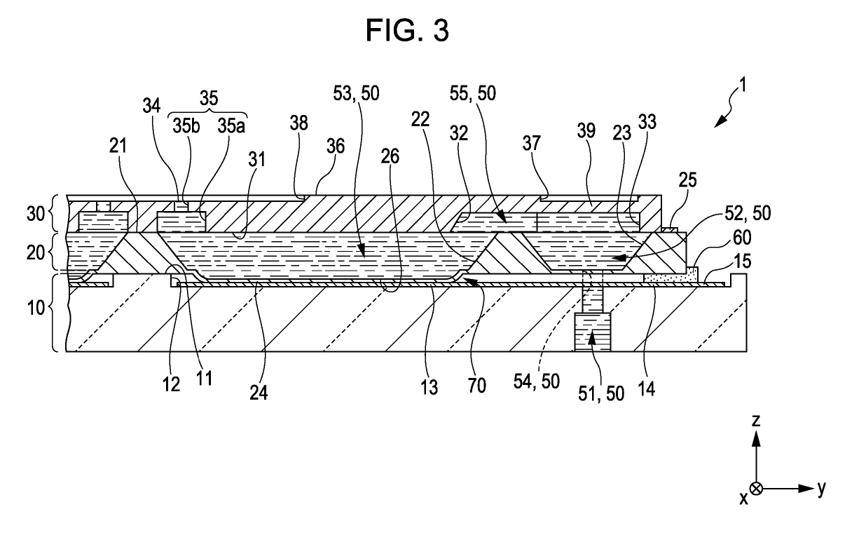

As an electrostatic force is generated due to the electric potential difference that has occurred therebetween, as shown in FIG. 3, the vibrating plate 24 is drawn downward due to the generated electrostatic force. Accordingly, the vibrating plate 24 becomes temporarily deformed inside the vibration plate deformation chamber 70. Consequently, the ink-retaining capacity of the pressure generation chamber 53 increases. Since the ink-retaining capacity of the pressure generation chamber 53 increases, ink flows from the common ink chamber 52 into the pressure generation chamber 53 via the ink-supply communication conduit 55. The amount of ink that flows from the common ink chamber 52 into the pressure generation chamber 53 via the ink-supply communication conduit 55 equals to the increased amount of the ink-retaining capacity of the pressure generation chamber 53.

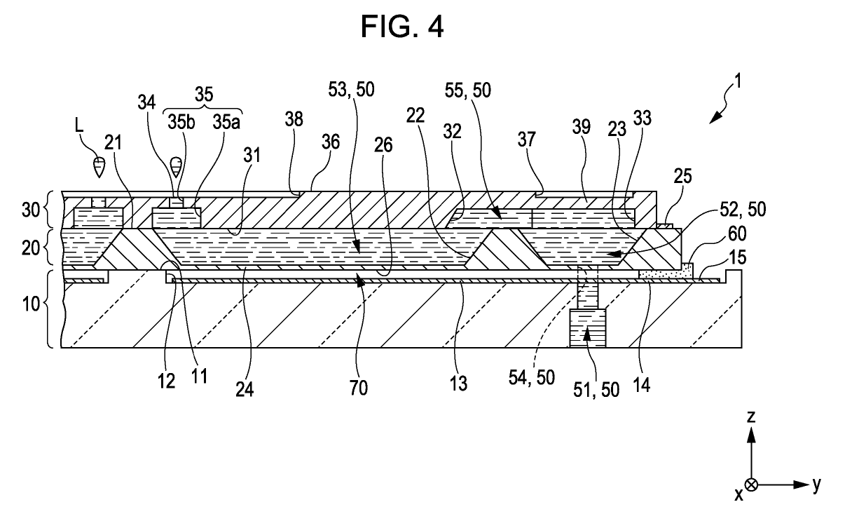

Thereafter, the application of the driving voltage is stopped. Accordingly, the electrostatic force disappears. As the electrostatic force disappears, the vibrating plate 24 returns to its original flat shape. Therefore, as shown in FIG. 4, the ink-retaining capacity of the pressure generation chamber 53 decreases. Consequently, ink is ejected out of the pressure generation chamber 53 through the nozzle opening 34. The amount of ink that is ejected out of the pressure generation chamber 53 through the nozzle opening 34 equals to the amount of ink that flowed from the common ink chamber 52 into the pressure generation chamber 53 via the ink-supply communication conduit 55, which is denoted as L herein.

When the vibrating plate 24 returns to its original flat shape, ink flows in the reverse direction inside the ink flow channel 50. That is, when ink is ejected from the nozzle hole 34, a backward wave fluctuation of ink is generated inside the ink flow channel 50. This wave motion of ink is directed backward from the pressure generation chamber 53 to the common ink chamber 52. Such a backward wave motion of ink causes the diaphragm 39 to vibrate after it has reached the common ink chamber 52. As a result thereof, the wave motion of ink retained in the common ink chamber 52 is attenuated. In other words, the diaphragm 39 absorbs the fluctuation (i.e., wave motion) of ink that is generated when ink is ejected from the nozzle hole 34. Therefore, it is possible to prevent any wave motion of ink that is generated inside the ink flow channel 50 when ink is ejected from a certain nozzle hole 34 from being communicated (i.e., transmitted) to any pressure generation chamber 53 that corresponds to other nozzle hole 34. This means that it is possible to prevent such a wave motion of ink that is generated inside the ink flow channel 50 when ink is ejected from the above-mentioned certain nozzle hole 34 from adversely affecting the ink-ejection performance of any nozzle hole 34 other than the above-mentioned certain nozzle hole 34.

Next, an explanation is given of a method for manufacturing the ink-jet head 1 according to the present embodiment of the invention, which has the configuration explained above. The manufacturing method according to the present embodiment of the invention has unique features in the formation of nozzles. Therefore, in the following description of a method for manufacturing the ink-jet head 1 according to the present embodiment of the invention, the formation of nozzles, that is, a nozzle formation process, is explained in detail.

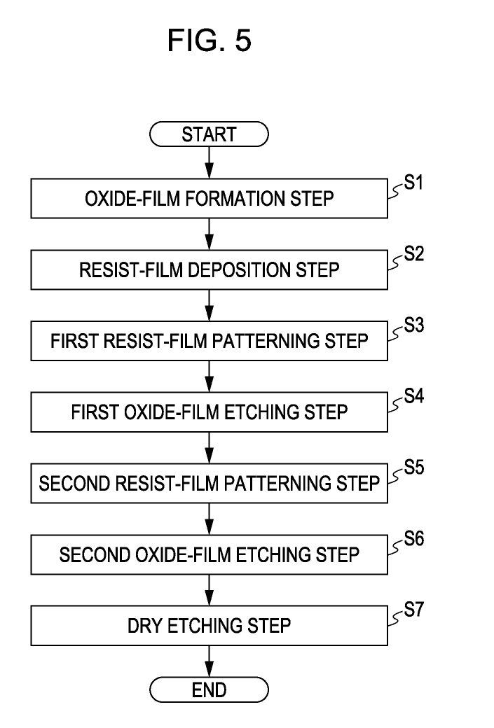

The nozzle formation process according to the present embodiment of the invention is made up of, as shown in the flowchart of FIG. 5, an oxide-film formation step (step S1) a resist-film deposition step (step S2), a first resist-film patterning step (step S3), a first oxide-film etching step (step S4), a second resist-film patterning step (step S5), a second oxide-film etching step (step S6), and a dry etching step (step S7).

The oxide-film formation step (step S1) is a process in which an oxide film 301 is formed on the surface of a silicon substrate 300 as shown in FIG. 6. The silicon substrate 300 is the base substrate substance of the nozzle substrate 30. More specifically, in this oxide-film formation step, the silicon substrate 300 that has a thickness of 180 μs is subjected to thermal oxidation. As a result of such thermal oxidation, a silicon oxide film that has a thickness of, for example, 1.2 μs or larger is formed on the surface of the silicon substrate 300. In this way, the oxide film 301 is formed on the surface of the silicon substrate 300.

The resist-film deposition step (step S2) is a process in which, as shown in FIG. 7, a resist film 302 is deposited on the surface of the oxide film 301, which was formed on the surface of the silicon substrate 300 in the preceding step S1. In this resist-film deposition step, the resist film 302 is formed on the surface of the oxide film 301 by a well-known film deposition method. For example, the resist film 302 is formed on the surface of the oxide film 301 by a spin coat method, a roll coat method, a spray coat method, or the like.

The first resist-film patterning step (step S3) is a process in which, as shown in FIG. 8, an opening 303 that corresponds to the minor diameter portion 35b of the nozzle 35 is formed through the resist film 302. Note that the minor diameter portion 35b of the nozzle 35 described in the present embodiment of the invention is a non-limiting example of the second concave portion according to an aspect of the invention, which is relatively small, as has already been explained above. In the first resist-film patterning step, the resist film 302 is exposed to light through a mask. Thereafter, the resist film 302 is washed with the use of a liquid developer. By this means, a desired pattern is formed in the resist film 302.

The first oxide-film etching step (step S4) is a process in which the oxide film 301 is subjected to etching by means of an etching solution (i.e., etchant). In the first oxide-film etching step, as shown in FIG. 9, the resist film 302, which is patterned in the preceding first resist-film patterning step (step S3), is used as a mask for etching the oxide film 301. In other words, the first oxide-film etching step is a process for wet etching the oxide film 301 while using the resist film 302 as a mask. For example, buffered hydrofluoric acid (HF: NH₄F=880 ml: 5610 ml) is used as an etchant in the first oxide-film etching step. A concave portion 304 is formed in the oxide film 301 through the first oxide-film etching step (step S4) explained above.

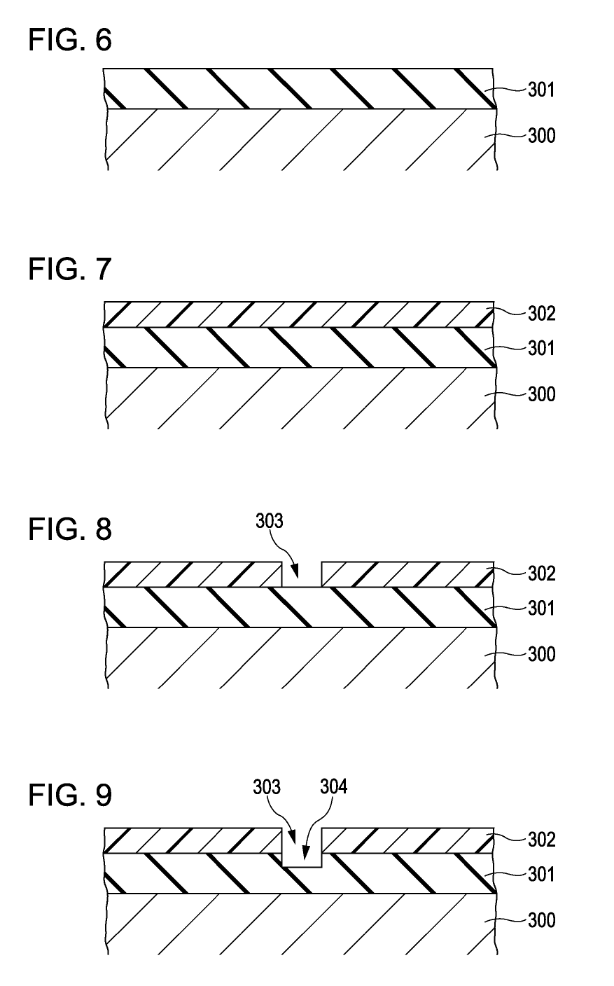

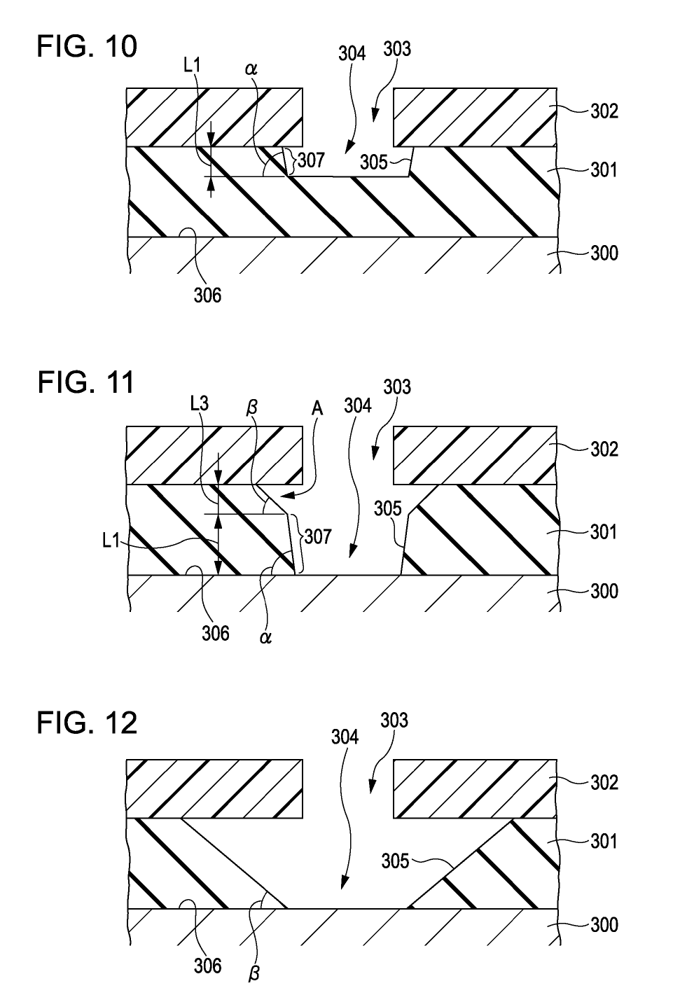

FIGS. 10, 11, and 12 are a set of sectional views that explains as to how the etching of the oxide film 301 progresses. In these FIGS. 10, 11, and 12, it is assumed that wet etching is continuously conducted in the first oxide-film etching step. Since wet etching is conducted as isotropic etching, as shown in FIG. 10, the oxide film 301 is etched away in an isotropic manner at a point in time that is immediately after the start of etching. Such isotropic etching originates from the aforementioned opening 303. Therefore, at this point in time that is immediately after the start of etching, the sidewall portion 305 of the concave 304, which is formed in the oxide film 301, has an angle of inclination a with respect to the surface 306 of the silicon substrate 300. In other words, just after the time when etching was started, the sidewall portion 305 of the concave 304 has an inclination angle α as measured from the surface 306 of the silicon substrate 300. As will be understood from the explanation given above, the angle of inclination α is obtained as a result of isotropic etching. In the course of etching after the start thereof, however, an etchant infiltrates into a gap region between the resist film 302 and the oxide film 301. For this reason, the etching of the oxide film 301 proceeds due to the etchant that has infiltrated into the gap region between the resist film 302 and the oxide film 301. Consequently, as illustrated in FIG. 11, after a short period of time has elapsed since the start of etching, a partial area A of the oxide film 301 that is etched by the etchant that has infiltrated into the gap region between the resist film 302 and the oxide film 301 appears. The sidewall portion 305 of the concave 304 has an angle of inclination β at the partial area (“gap-etched” area) A of the oxide film 301 with respect to the surface 306 of the silicon substrate 300. As illustrated therein, the angle of inclination β that is formed at the gap-etched area A thereof is smaller than the above-mentioned angle of inclination α, which is obtained through isotropic etching. As wet etching is further continued, the inclination angle of the sidewall portion 305 with respect to the surface 306 of the silicon substrate 300 becomes β at the entire area of the oxide film 301, that is, not only at the partial area A thereof, as shown in FIG. 12. The first-mentioned angle of inclination α is obtained through isotropic etching as a steady value that is free from any substantial variation and/or deviation. In contrast, the second-mentioned angle of inclination β is not a steady value because it depends on the amount of infiltration of an etchant. The amount of infiltration of an etchant varies depending on various conditions. Therefore, the shape of the partial area A of the oxide film 301 that is etched by an etchant that has infiltrated into the gap region between the resist film 302 and the oxide film 301 could significantly differ from one to another. That is, variation/deviation in the shape of the partial area A of the oxide film 301 that is etched by an etchant that has infiltrated into the gap region between the resist film 302 and the oxide film 301 will be large. For this reason, if the silicon substrate 300 is subjected to etching while using the concave portion 304 that has the sidewall 305 whose angle of inclination is β, there occurs some variation/deviation in the shape of a concave that is formed in the silicon substrate 300. In addition, if the sidewall portion 305 of the concave 304, which is formed in the oxide film 301, has an angle of inclination β with respect to the surface 306 of the silicon substrate 300, the thickness of the sidewall portion 305 thereof is smaller in comparison with a case where the sidewall portion 305 of the concave 304 has an angle of inclination α with respect to the surface 306 of the silicon substrate 300. Therefore, if the silicon substrate 300 is subjected to etching while using the concave portion 304 of the oxide film 301, which has the sidewall 305 whose angle of inclination is β, it is likely that the sidewall portion 305 thereof will disappear in a subsequent dry etching process, which makes it practically impossible for the concave portion 304 of the oxide film 301 to function as a mask with reliable performance. For this reason, if the silicon substrate 300 is subjected to etching while using the concave portion 304 that has the sidewall 305 whose angle of inclination is β, there occurs some variation/deviation in the shape of a concave that is formed in the silicon substrate 300.

As explained above, if the silicon substrate 300 is subjected to etching while using the concave portion 304 that has the sidewall 305 whose angle of inclination is β there occurs some variation/deviation in the shape of a concave that is formed in the silicon substrate 300. The shape of a concave portion that is formed in the oxide film in the second oxide-film etching step, which will be executed later, depends on the shape of the concave portion that is formed in the first oxide-film etching step. In other words, the shape of a portion that actually functions as a mask when the silicon substrate 300 is subjected to dry etching depends on the shape of the concave portion 304 that is formed in the first oxide-film etching step. That is, if the angle of inclination measured at the sidewall portion of the concave 304 is β, the angle of inclination measured at the sidewall portion of a concave that is formed in the oxide film 301 in the subsequent second oxide-film etching step will be approximately β. This causes the shapes of concave portions that are formed in the silicon substrate 300 to differ from one to another.

In order to overcome such a disadvantage, in the nozzle formation process of a method for manufacturing the ink-jet head 1 according to the present embodiment of the invention, the length of an etching time period in the first oxide-film etching step is set at such a value that the sidewall portion 305 of the concave 304 that is formed in the oxide film 301 has an inclined portion 307 whose angle of inclination is α, which is obtained through isotropic etching. That is, in the nozzle formation process of a method for manufacturing the ink-jet head 1 according to the present embodiment of the invention, the length of an etching time period in the first oxide-film etching step is set at such a value that the sidewall portion 305 of the concave 304 that is formed in the oxide film 301 (refer to FIG. 10 or FIG. 11) has an angle of inclination α when it is measured at a region that is closest to the silicon substrate 300. In other words, in the nozzle formation process of a method for manufacturing the ink-jet head 1 according to the present embodiment of the invention, the length of an etching time period in the first oxide-film etching step is set at such a value that the sidewall portion 305 of the concave 304 that is formed in the oxide film 301 has the above-mentioned inclined portion 307 whose angle of inclination is α at a region that is closest to the silicon substrate 300. Since the oxide film 301 will be further etched in the subsequent second oxide-film etching step, the depth-directional distance L1 of the inclined portion 307 (refer to FIG. 10 or FIG. 11) is set at a value that is larger than that of the depth-directional distance L2 of the oxide film 301 that will be etched in the second oxide-film etching step (refer to FIG. 14). In the following description of this specification and the recitation of appended claims, the term “(depth-directional) distance” is used to mean a certain depth value without any intention to narrow the scope of the invention. Note that the height of the inclined portion 307 can be controlled on the basis of the length of the etching time period mentioned above.

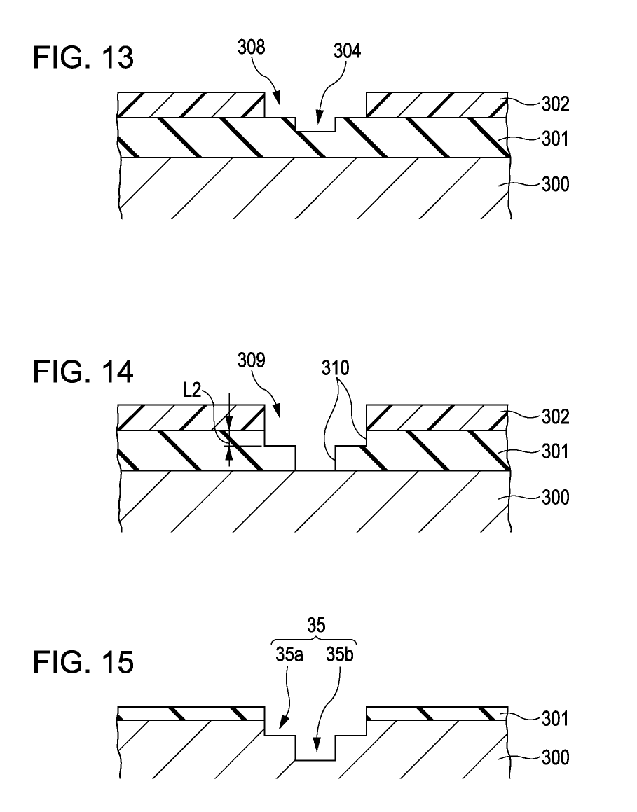

The second resist-film patterning step (step S5) is a process in which, as shown in FIG. 13, the opening 303 that is formed through the resist film 302 in the first resist-film patterning step (step S3) is widened. In this second resist-film patterning step, an enlarged opening 308 is formed as a result of widening the opening 303. The enlarged opening 308 corresponds to the major diameter portion 35a of the nozzle 35. Note that the major diameter portion 35a of the nozzle 35 described in the present embodiment of the invention is a non-limiting example of the first concave portion according to an aspect of the invention, which is relatively large, as has already been explained above. The second resist-film patterning step (step S5) is performed in the same manner as the first resist-film patterning step (step S3) explained above. That is, in the second resist-film patterning step, the resist film 302 is exposed to light through a mask. Thereafter, the resist film 302 is washed with the use of a liquid developer. By this means, a desired pattern is formed in the resist film 302.

The second oxide-film etching step (step S6) is a process in which the oxide film 301 is subjected to etching by means of an etchant. In the second oxide-film etching step, as shown in FIG. 14, the resist film 302, which is patterned in the preceding second resist-film patterning step (step S5), is used as a mask for etching the oxide film 301. In other words, the second oxide-film etching step is a process for wet etching the oxide film 301 while using the resist film 302 as a mask. A concave portion 309 is formed in the oxide film 301 through the second oxide-film etching step (step S6) explained above. In the second oxide-film etching step, the concave portion 304, which was formed in the first oxide-film etching step, is also etched by an etching solution. Since it is conducted as isotropic etching, the second oxide-film etching progresses while maintaining the shape of the concave portion 304 basically, that is, not in a strict meaning. As has already been explained above, the depth-directional distance L1 of the inclined portion 307 of the concave 304, which was formed in the first oxide-film etching step, is set at a value that is larger than that of the depth-directional distance L2 of the oxide film 301 that will be etched in the second oxide-film etching step. Therefore, the shape of the inclined portion 307 of the concave 304 is maintained without any significant loss during the execution of the second oxide-film etching process. Thus, the sidewall portion 310 of the concave 309 that is formed in the oxide film 301 has an angle of inclination α when it is measured at a region that is closest to the silicon substrate 300. Although the second oxide-film etching progresses while basically maintaining the shape of the concave portion 304, the shape of the concave portion 304, which was formed in the oxide film 301 in the first oxide-film etching step, is not kept perfectly intact during the execution of the second oxide-film etching process in a strict sense. That is, the minute shape of the concave portion 304 is not maintained during the execution of the second oxide-film etching process. Therefore, if, for example, wet etching is conducted in such a manner that the depth-directional distance L3 (refer to FIG. 11) of the aforementioned partial area A of the oxide film 301 that is etched by an etchant that has infiltrated into a gap region between the resist film 302 and the oxide film 301 during the execution of the first oxide-film etching process is set at a value that is smaller than that of the depth-directional distance L1 of the oxide film 301 that will be etched in the second oxide-film etching step, it is possible to ensure that a concave portion is free from the adverse effects of the “gap-etched” partial area A thereof, which has already been explained earlier while referring to FIG. 11. Note that it is possible to adjust the depth-directional distance L3 (refer to FIG. 11) of the aforementioned partial area A of the oxide film 301 that is etched by an etchant that has infiltrated into a gap region between the resist film 302 and the oxide film 301 during the execution of the first oxide-film etching process by controlling the length of an etching time period in the first oxide-film etching step.

The dry etching step (step S7) is a process that follows the second oxide-film etching step. The nozzle 35, which is made up of the major diameter portion 35a and the minor diameter portion 35b, is formed in the dry etching step. As shown in FIG. 15, the silicon substrate 300 is subjected to dry etching while using the oxide film 301 as a mask. More specifically, for example, anisotropic dry etching is conducted in this step through ICP discharge, which uses carbon fluoride (CF, CF₄) and sulfur hexafluoride (SF6) as an etchant gas, thereby forming the nozzle 35, which is made up of the major diameter portion 35a and the minor diameter portion 35b. The carbon fluoride component of the etchant gas mentioned above is used for protecting the sidewall portion of the concave. With such CF protection, etching does not proceed (i.e., progress) at the sidewall of the concave portion. On the other hand, the sulfur hexafluoride component of the etchant gas mentioned above is used for accelerating progress in the vertical etching of the silicon substrate 300.

After the execution of a series of steps explained above, that is, the oxide-film formation step (step S1), the resist-film deposition step (step S2), the first resist-film patterning step (step S3), the first oxide-film etching step (step S4), the second resist-film patterning step (step S5), the second oxide-film etching step (step S6), and the dry etching step (step S7), the oxide film 301 is subjected to washing with the use of, for example, fluorinated acid solution (e.g., HF: H₂O=1:5 vol, 25 C.°) so as to form the nozzles 35.

When the nozzle substrate 30 is formed, the aforementioned concave portions 37 and 38 as well as the aforementioned groove portions 32 and 33 are formed in the same etching process as the formation of the nozzle 35. As explained in detail above, the nozzle substrate 30 is formed through the etching of a silicon substrate. The cavity substrate 20 is also formed through the etching of a silicon substrate.

After the formation of these substrates, the electrode substrate 10 and the cavity substrate 20 are adhered to each other with the use of, for example, anode coupling, without any limitation thereto, whereas the cavity substrate 20 and the nozzle substrate 30 are adhered to each other with the use of an adhesive. In this way, the ink-jet head 1 according to the present embodiment of the invention is manufactured.

The method for manufacturing the ink-jet head 1 according to the present embodiment of the invention offers the following advantageous effects without any limitation thereto. The length of an etching time period in the first oxide-film etching step (step S4) is set at such a value that the sidewall portion 305 of the concave 304 that is formed in the oxide film 301 has the inclined portion 307 whose angle of inclination is a, which is obtained as a result of isotropic etching. In addition, the depth-directional distance L1 of the inclined portion 307 of the concave 304, which is formed in the first oxide-film etching step, is set at a value that is larger than that of the depth-directional distance L2 of the oxide film 301 that is etched in the second oxide-film etching step (step S6). In the process of wet etching, the amount of an etchant that infiltrates into a gap region between the resist film 302 and the oxide film 301 has no influence on the formation of an isotropic-etch portion that has an angle of inclination a obtained as a result of isotropic etching, which is the inclined portion 307 in the nozzle formation process of a method for manufacturing the ink-jet head 1 according to the present embodiment of the invention. Since the inclined portion 307 is not affected at all by the amount of an etchant that infiltrates into a gap region between the resist film 302 and the oxide film 301, it always offers a steady shape that does not depend on conditions and thus is substantially free from variation or deviation. The depth-directional distance L1 of the inclined portion 307 of the concave 304, which is formed in the first oxide-film etching step (step S4), is set at a value that is larger than that of the depth-directional distance L2 of the oxide film 301 that is etched in the second oxide-film etching step (step S6). Therefore, the shape of the inclined portion 307 of the concave 304, which has an angle of inclination α, is maintained without any significant loss during the execution of the second oxide-film etching process. Thus, the sidewall portion 310 of the concave 309 that is formed in the oxide film 301 has an angle of inclination α when it is measured at a region that is closest to the silicon substrate 300. Accordingly, in the dry etching step (step S7), it is possible to conduct the etching of the silicon substrate 300 while using a regional portion of the oxide film 301 corresponding to the inclined portion 307, which is substantially free from variation/deviation in shape, as a mask. That is, in the dry etching step, it is possible to conduct the etching of the silicon substrate 300 while using a region that is closest to the silicon substrate 300 in the sidewall portion 310 of the concave 309, which is formed in the oxide film 301, as a mask. For this reason, it is possible to form, in the silicon substrate 300, the minor diameter portion 35b of the nozzle 35 that is substantially free from variation/deviation in shape. The minor diameter portion 35b of each nozzle 35 functions as the tip (i.e., front end) of an ink ejection port from which an ink drop is discharged. In this respect, a method for manufacturing the ink-jet head 1 according to the present embodiment of the invention makes it possible to form the nozzles 35 each of which has a front end that is substantially free from variation/deviation in shape.

Moreover, in the nozzle formation process of a method for manufacturing the ink-jet head 1 according to the present embodiment of the invention, in the first oxide-film etching step (step S4), etching is conducted in such a manner that the sidewall portion 305 of the concave 304 that is formed in the oxide film 301 has the inclined portion 307 whose angle of inclination is α, which is obtained as a result of isotropic etching. In addition, in the first oxide-film etching step (step S4), etching is conducted in such a manner that the depth-directional distance L1 of the inclined portion 307 of the concave 304 is set at a value that is larger than that of the depth-directional distance L2 of the oxide film 301 that is etched in the second oxide-film etching step (step S6). Therefore, a method for manufacturing the ink-jet head 1 according to the present embodiment of the invention makes it possible to form the nozzles 35 each of which has a front end that is substantially free from variation/deviation in shape.

Furthermore, in the nozzle formation process of a method for manufacturing the ink-jet head 1 according to the present embodiment of the invention, in the first oxide-film etching step (step S4), etching is conducted in such a manner that the depth-directional distance L3 of the partial area A of the oxide film 301 that is etched by an etchant that has infiltrated into a gap region between the resist film 302 and the oxide film 301 during the execution of the first oxide-film etching process is set at a value that is smaller than that of the depth-directional distance L2 of the oxide film 301 that will be etched in the second oxide-film etching step. For this reason, in the second oxide-film etching step (step S6), it is possible to etch away the above-mentioned regional portion A of the oxide film 301 that is etched by an etchant that has infiltrated into a gap region between the resist film 302 and the oxide film 301 during the execution of the first oxide-film etching process (step S4). By this means, it is possible to ensure that a concave portion 309 that is formed in the oxide film 301 is free from the adverse effects of the etchant that has infiltrated into the gap region between the resist film 302 and the oxide film 301. Thus, a method for manufacturing the ink-jet head 1 according to the present embodiment of the invention makes it possible to form the nozzle 35 that has a shape substantially free from variation/deviation, including the major diameter portion 35a thereof.

### Configuration of Fluid Ejecting Apparatus

Next, with reference to FIG. 16, an example of the configuration of an ink-jet printer 100 according to the present embodiment of the invention is explained below. The ink-jet printer 100 according to the present embodiment of the invention is provided with the ink-jet head 1 according to the foregoing exemplary embodiment of the invention. FIG. 16 is a perspective view that schematically illustrates an example of the inner configuration of an ink-jet printer 100 that is provided with an ink-jet head manufactured by a method according to the present embodiment of the invention.

As illustrated in FIG. 16, the ink-jet printer 100 is provided with a paper-feed unit 150, a paper-transport unit 160, a carriage unit 170, a maintenance unit 180, and a driving unit 190.

The paper-feed unit 150 feeds a sheet of printing paper, which is not shown in the drawing, to the ink-jet printer 100. The paper-feed unit 150 is provided with, for example, a paper-feed tray 151 and a paper pick-up roller, without any limitation thereto. A plurality of sheets of printing paper can be stacked on the paper-feed tray 151. As its name indicates, the paper pick-up roller picks up a sheet of printing paper from the paper-feed tray 151.

The paper-transport unit 160 transports the sheet of printing paper that has been fed from the paper-feed unit 150. The paper-transport unit 160 is provided with, for example, a pair of feed-side paper-transport rollers and a pair of eject-side paper-transport rollers, without any limitation thereto. The pair of feed-side paper-transport rollers is provided at an upstream position (i.e., paper-feed-side position) when viewed from a carriage unit 170 along the path of paper transportation whereas the pair of eject-side paper-transport rollers is provided at a downstream position (i.e., paper-eject-side position) when viewed from the carriage unit 170 along the path of paper transportation.

The ink-jet head 1 according to the foregoing exemplary embodiment of the invention is provided at the lower surface of the carriage unit 170. The carriage unit 170 travels in a direction orthogonal to the direction of the transportation of a sheet of print target paper so as to move the ink-jet head 1. The carriage unit 170 is provided with a carriage 171 in addition to the ink-jet head 1. Ink cartridges 200 are detachably attached to the carriage 171. Each of the ink cartridges 200 contains ink that is to be supplied to the ink-jet head 1. Since the carriage unit 170 is provided with the ink-jet head 1 according to the foregoing exemplary embodiment of the invention, the ink-jet head 1 also moves in a direction perpendicular to the direction of the transportation of a sheet of print target paper as the carriage unit 171 travels. These ink cartridges 200 are made up of, for example, four ink containers that are separated from one another. These ink cartridges 200 correspond to four ink colors of black, yellow, cyan, and magenta, though not necessarily limited thereto. These ink cartridges 200 can be replaced independently of one another.

The maintenance unit 180 is provided so as to perform maintenance of the ink-jet head 1. The maintenance unit 180 is provided at the side of the paper-transport unit 160. The maintenance unit 180 is provided with a capping mechanism, a pumping device, and a wiping mechanism, all of which are not illustrated in the drawing.

The driving unit 190 is provided with a driving motor 191 and a power transmission mechanism. The driving motor 191 functions as a driving source that supplies a motor power in the configuration of the ink-jet printer 100. The power transmission mechanism, which is not shown in the drawing, communicates (i.e., transmits) the driving power that is supplied from the driving motor 191 to each of the paper-feed unit 150, the paper-transport unit 160, the carriage unit 170, and the maintenance unit 180.

In the configuration of the ink-jet printer 100 according to the present embodiment of the invention, a control unit that is not shown in the drawing controls the operation of the driving unit 190, the paper-feed unit 150, and the paper-transport unit 160 so as to transport a sheet of printing paper. In addition, the control unit controls the operation of the carriage unit 170 so as to cause the ink-jet head 1 to eject ink onto a sheet of printing paper. In this way, a print image is formed on the sheet of printing paper. In addition, in the configuration of the ink-jet printer 100 according to the present embodiment of the invention, the above-mentioned control unit that is not shown in the drawing controls the operation of the carriage unit 170, the maintenance unit 180, and the driving unit 190 so as to perform maintenance of the ink-jet head 1.

The ink-jet printer 100 having the configuration explained above is manufactured by assembling various kinds of components that include the ink-jet head 1, which is manufactured as explained above. A method for manufacturing the ink-jet head 1 according to an exemplary embodiment of the invention makes it possible to form the nozzles 35 each of which has a front end that is substantially free from variation/deviation in shape. The front end of the nozzle 35 that is substantially free from variation/deviation in shape corresponds to the open end (i.e., nozzle hole) 34 and the minor diameter portion 35b. Therefore, a method for manufacturing a fluid ejecting apparatus according to an exemplary embodiment of the invention, which includes a method for manufacturing a fluid ejecting head according to an exemplary embodiment of the invention, makes it possible to manufacture, for example, the ink-jet printer 100 that is provided with the ink-jet head 1 that features the nozzles 35 each of which has a front end that is substantially free from variation/deviation in shape. Therefore, a method for manufacturing a fluid ejecting apparatus according to an exemplary embodiment of the invention makes it possible to manufacture the ink-jet printer 100 that offers excellent ink-ejection performance.

### Method for Etching Silicon Substrate

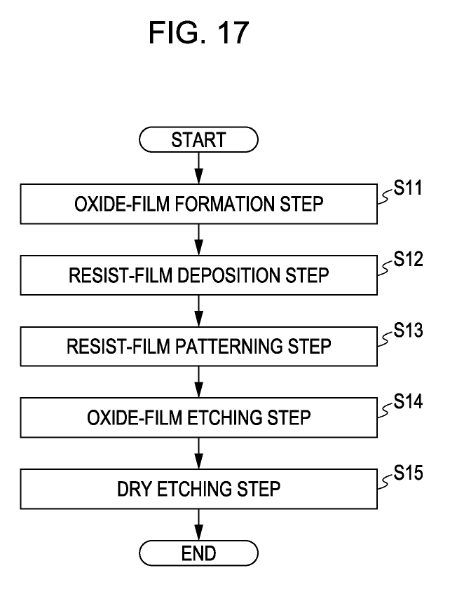

Next, with reference to FIGS. 17-24, a method for etching a silicon substrate is explained below. FIG. 17 is a flowchart that schematically illustrates an example of a method for etching a silicon substrate according to an exemplary embodiment of the invention. FIGS. 18-24 are a set of diagrams that schematically illustrates an example of a method for etching a silicon substrate according to an exemplary embodiment of the invention.

The method for etching a silicon substrate according to the present embodiment of the invention is made up of, as shown in the flowchart of FIG. 17, an oxide-film formation step (step S11), a resist-film deposition step (step S12), a resist-film patterning step (step S13), an oxide-film etching step (step S14), and a dry etching step (step S15).

The oxide-film formation step (step S11) is a process in which an oxide film 401 is formed on the surface of a silicon substrate 400 as shown in FIG. 18. More specifically, in this oxide-film formation step, the silicon substrate 400 is subjected to thermal oxidation. As a result of such thermal oxidation, a silicon oxide film is formed on the surface of the silicon substrate 400. In this way, the oxide film 401 is formed on the surface of the silicon substrate 400.

The resist-film deposition step (step S12) is a process in which, as shown in FIG. 19, a resist film 402 is deposited on the surface of the oxide film 401, which was formed on the surface of the silicon substrate 400 in the preceding step S11. In this resist-film deposition step, the resist film 402 is formed on the surface of the oxide film 401 by a well-known film deposition method. For example, the resist film 402 is formed on the surface of the oxide film 401 by a spin coat method, a roll coat method, a spray coat method, or the like.

The resist-film patterning step (step S13) is a process in which, as shown in FIG. 20, an opening 403 is formed through the resist film 402. The opening 403 that is formed through the resist film 402 in this step corresponds to a concave portion that is to be formed in the silicon substrate 400. In the resist-film patterning step, the resist film 402 is exposed to light through a mask. Thereafter, the resist film 402 is washed with the use of a liquid developer. By this means, a desired pattern is formed in the resist film 402.

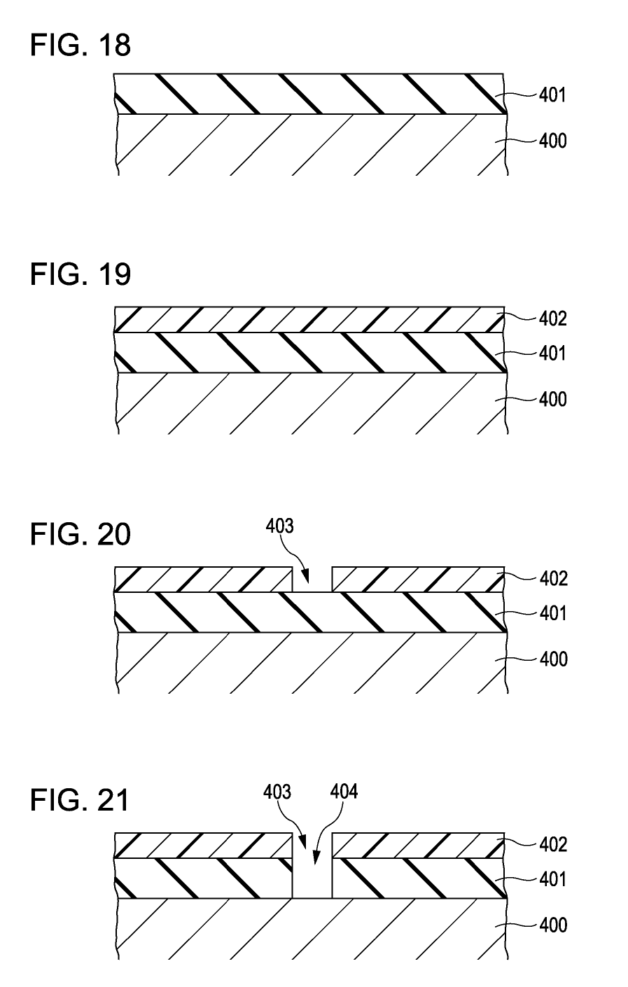

The oxide-film etching step (step S14) is a process in which the oxide film 401 is subjected to etching by means of an etching solution (i.e., etchant). In the oxide-film etching step, as shown in FIG. 21, the resist film 402, which is patterned in the preceding resist-film patterning step (step S13), is used as a mask for etching the oxide film 401. In other words, the oxide-film etching step is a process for wet etching the oxide film 401 while using the resist film 402 as a mask. A concave portion 404 is formed in the oxide film 401 through the oxide-film etching process explained above. For example, buffered hydrofluoric acid (HF: NH₄F=880 ml: 5610 ml) is used as an etchant in the oxide-film etching step.

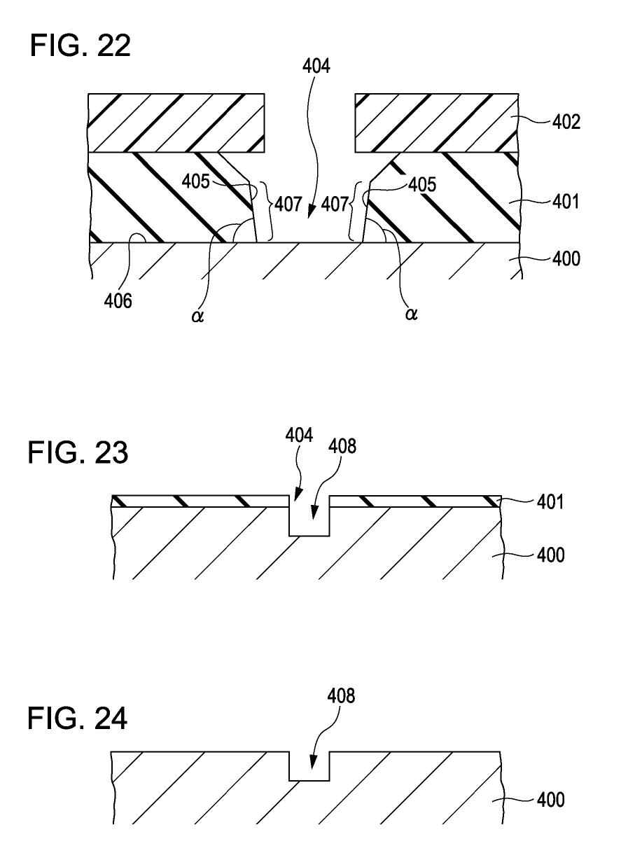

FIG. 22 is an enlarged sectional view that schematically illustrates an example of the etching of the oxide film 401 that is conducted in the oxide-film etching step (step S14). As shown in the drawing, the length of an etching time period in the oxide-film etching step is set at such a value that the sidewall portion 405 of the concave 404 that is formed in the oxide film 401 has an inclined portion 407 whose angle of inclination is a with respect to the surface 406 of the silicon substrate 400. That is, in a method for etching a silicon substrate according to the present embodiment of the invention, the length of an etching time period in the oxide-film etching step is set at such a value that the sidewall portion 405 of the concave 404 that is formed in the oxide film 401 (refer to FIG. 22) has an angle of inclination α when it is measured at a region that is closest to the silicon substrate 400. In other words, in a method for etching a silicon substrate according to the present embodiment of the invention, the length of an etching time period in the oxide-film etching step is set at such a value that the sidewall portion 405 of the concave 404 that is formed in the oxide film 401 has the above-mentioned inclined portion 407 whose angle of inclination is α at a region that is closest to the silicon substrate 400.

The dry etching step (step S15) is a process that follows the oxide-film etching step. As shown in FIG. 23, the silicon substrate 400 is subjected to dry etching while using the oxide film 401 as a mask. By this means, a concave portion 408 is formed in the silicon substrate 400. More specifically, for example, anisotropic dry etching is conducted in this step through ICP discharge, which uses carbon fluoride (CF, CF₄) and sulfur hexafluoride (SF6) as an etchant gas, thereby forming the concave portion 408. The carbon fluoride component of the etchant gas mentioned above is used for protecting the sidewall portion of the concave. With such CF protection, etching does not proceed (i.e., progress) at the sidewall of the concave portion. On the other hand, the sulfur hexafluoride component of the etchant gas mentioned above is used for accelerating progress in the vertical etching of the silicon substrate 400.

After the execution of a series of steps explained above, that is, the oxide-film formation step (step S11) the resist-film deposition step (step S12), the resist-film patterning step (step S13), the oxide-film etching step (step S14), and the dry etching step (step S15), the oxide film 401 is subjected to washing with the use of, for example, fluorinated acid solution (e.g., HF: H₂O=1:5 vol, 25 C.°). In this way, the silicon substrate 400 that has the concave portion 408 (refer to FIG. 24) is manufactured. That is, the silicon substrate 400 is etched in such a manner that the concave portion 408 is formed.

That is, in a method for etching a silicon substrate according to the present embodiment of the invention, the length of an etching time period in the oxide-film etching step is set at such a value that the sidewall portion 405 of the concave 404 that is formed in the oxide film 401 has an angle of inclination α when it is measured at a region that is closest to the silicon substrate 400. In other words, in a method for etching a silicon substrate according to the present embodiment of the invention, the length of an etching time period in the oxide-film etching step is set at such a value that the sidewall portion 405 of the concave 404 that is formed in the oxide film 401 has the above-mentioned inclined portion 407 whose angle of inclination is α at a region that is closest to the silicon substrate 400. In the process of wet etching, the amount of an etchant that infiltrates into a gap region between the resist film 402 and the oxide film 401 has no influence on the formation of an isotropic-etch portion that has an angle of inclination α obtained as a result of isotropic etching, which is the inclined portion 407 in a method for etching a silicon substrate according to the present embodiment of the invention. Since the inclined portion 407 is not affected at all by the amount of an etchant that infiltrates into a gap region between the resist film 402 and the oxide film 401, it always offers a steady shape that does not depend on conditions and thus is substantially free from variation or deviation. Accordingly, in the dry etching step (step S15), it is possible to conduct the etching of the silicon substrate 400 while using the inclined portion 407, which is substantially free from variation/deviation in shape, as a mask. For this reason, it is possible to form, in the silicon substrate 400, the concave portion 408 that is substantially free from variation/deviation in shape. That is, a method for etching a silicon substrate according to the present embodiment of the invention makes it possible to form a concave portion (nozzle) that is substantially free from variation/deviation in shape in a substrate that is made of silicon (nozzle substrate).

Although preferred embodiments of the invention are explained above while referring to the accompanying drawings, needless to say, the scope of the invention is not limited to any specific embodiment or example explained above. For example, exemplary embodiments of the invention explained above may be combined with each other or one another. In addition, the invention may be modified, altered, changed, adapted, and/or improved within a range not departing from the gist and/or spirit of the invention apprehended by a person skilled in the art from explicit and implicit description made herein, where such a modification, an alteration, a change, an adaptation, and/or an improvement is also covered by the scope of the appended claims.

For example, in the foregoing description of exemplary embodiments of the invention, an ink-jet printer that is provided with a single ink-jet head is taken as an example of various kinds of fluid ejecting apparatuses. However, the technical scope of the invention is not limited thereto. For example, the invention can be applied to a method for manufacturing an ink-jet printer that is provided with a plurality of ink-jet heads. In addition, the technical scope of the invention is not limited to a method for manufacturing a serial ink-jet printer. For example, the invention can be applied to a method for manufacturing a line-head ink-jet printer.

Moreover, in the foregoing description of exemplary embodiments of the invention, an ink-jet printer is taken as an example of an ink-jet recording apparatus, which is a non-limiting example of various kinds of fluid ejecting apparatuses. Notwithstanding the above, however, the technical scope of the invention is not limited to an ink-jet printer. For example, the invention can be applied to a method for manufacturing other types of recording apparatuses that include but not limited to a copying machine and a facsimile machine.

In the foregoing description of exemplary embodiments of the invention, an ink-jet recording apparatus that ejects ink as a fluid is taken as an example of various kinds of fluid ejecting apparatuses. However, the scope of the invention is not limited to such an example. That is, the invention is also applicable to a method for manufacturing a variety of other fluid ejecting apparatuses that eject or discharge various kinds of fluid other than ink. The invention is further applicable to a method for manufacturing a fluid ejecting apparatus that ejects a liquid/liquefied matter/material that is made as a result of dispersion or dissolution of particles of functional material(s) into liquid. The invention is further applicable to a method for manufacturing a fluid ejecting apparatus that ejects a gel substance. The invention is further applicable to a method for manufacturing a fluid ejecting apparatus that ejects a semi-solid or solid substance that can be ejected as a fluid. A non-limiting example thereof is any powder or a granular matter/material that contains/includes toner. It should be noted that the scope of the invention is not limited to those enumerated above.

In the foregoing description of exemplary embodiments of the invention, an ink-jet recording apparatus that ejects ink as a fluid is taken as an example of various kinds of fluid ejecting apparatuses. However, the scope of the invention is not limited to such an example. The invention is also applicable to a method for manufacturing a variety of other fluid ejecting apparatuses that eject or discharge various kinds of fluid other than ink. That is, the invention can be applied to a method for manufacturing a fluid ejecting apparatus that is provided with a fluid ejecting head that ejects fluid specific to each application/use onto a fluid ejection target medium, thereby causing the fluid to adhere to the fluid ejection target medium. In addition to an ink-jet recording apparatus (ink-jet printer) described in the foregoing exemplary embodiment of the invention, a fluid ejecting apparatuses to which the invention is applicable encompasses a wide variety of other types of apparatuses that ejects fluid in which, for example, a color material or an electrode material is dispersed in a dispersion medium or dissolved in a dissolution medium, though not necessarily limited thereto. Herein, the color material may be, for example, one that is used in the production of color filters for a liquid crystal display device or the like. The electrode material (i.e., conductive paste) may be, though not limited thereto, one that is used for electrode formation of an organic EL display device, a surface/plane emission display device (FED), and the like.

A fluid ejecting apparatuses to which the invention is applicable further encompasses a wide variety of other types of apparatuses such as one that ejects a living organic material used for production of biochips or one that is provided with a sample ejection head functioning as a high precision pipette and ejects fluid as a sample therefrom.

Further in addition, the invention is applicable to, and thus can be embodied as, a fluid ejecting apparatus that ejects, with high precision, lubricating oil onto a precision instrument and equipment including but not limited to a watch and a camera. Moreover, the invention is applicable to and thus can be embodied as a fluid ejecting apparatus that ejects fluid of a transparent resin such as an ultraviolet ray curing resin or the like onto a substrate so as to form a micro hemispherical lens (optical lens) that is used in an optical communication element or the like. Furthermore, the invention is applicable to and thus can be embodied as a fluid ejecting apparatus that ejects an etchant such as acid or alkali that is used for the etching of a substrate or the like. In addition, the invention is applicable to and thus can be embodied as a fluid ejecting apparatus that ejects a gel fluid. Moreover, the invention is applicable to and thus can be embodied as a toner jet recording apparatus that ejects various kinds of solid such as powder or a granular matter/material that includes toner, without any limitation thereto. Without any intention to limit the technical scope of the invention to those enumerated or explained above, the invention can be applied to a method for manufacturing a variety of fluid ejecting apparatuses that eject or discharge various kinds of fluid such as those enumerated or explained above.

What is claimed is:

1. A method for manufacturing a fluid ejecting head that includes a nozzle formation process in which a nozzle is formed in a nozzle substrate, the nozzle having a first concave portion and a second concave portion that is smaller than that of the first concave portion, the second concave portion being formed so as to correspond to the first concave portion, the fluid ejecting head being assembled by putting the nozzle substrate, a cavity substrate, and an electrode substrate together, the nozzle substrate being formed through the nozzle formation process, the nozzle formation process of the method for manufacturing a fluid ejecting head comprising:
an oxide-film formation of forming an oxide film on the surface of the nozzle substrate;
a resist-film deposition of depositing a resist film on the surface of the oxide film;
a first resist-film patterning of forming an opening that corresponds to the second concave portion through the resist film;
a first oxide-film etching of etching the oxide film with the use of an etchant while using the resist film as a mask after the first resist-film patterning mentioned above;
a second resist-film patterning of widening the opening of the resist film to a larger opening that corresponds to the first concave portion after the first oxide-film etching mentioned above;
a second oxide-film etching of etching the oxide film with the use of the etchant while using the resist film as a mask after the second resist-film patterning mentioned above; and
a dry etching of forming the first concave portion and the second concave portion as a result of dry etching the nozzle substrate while using the oxide film as a mask after the second oxide-film etching mentioned above,
wherein, in the first oxide-film etching mentioned above, etching is conducted in such a manner that the sidewall portion of a concave that is formed in the oxide film has an inclined portion that has an angle of inclination that is obtained through isotropic etching and further that the depth-directional distance of the inclined portion is set at a value that is larger than that of the depth-directional distance of the oxide film that is etched in the second oxide-film etching mentioned above.

2. The method for manufacturing a fluid ejecting head according to claim 1, wherein, in the first oxide-film etching mentioned above, etching is conducted in such a manner that the depth-directional distance of an area of the oxide film that is etched by the etchant that has infiltrated into a gap between the resist film and the oxide film during the execution of the first oxide-film etching mentioned above is set at a value that is smaller than that of the depth-directional distance of the oxide film that is etched in the second oxide-film etching mentioned above.

3. A method for manufacturing a fluid ejecting apparatus that is provided with a fluid ejecting head that ejects fluid onto a fluid ejection target medium, wherein the fluid ejecting head is manufactured by the above-mentioned method for manufacturing a fluid ejecting head according to claim 1.
